(19) United States
(12) Patent Application Publication
(10) Pub. No.: US 2024/0095641 A1
(43) Pub. Date: Mar. 21, 2024

(54) Illuminate dashboard

(71) Applicant: Aaron Lee Smith, Chesapeake, VA (US)

(72) Inventor: Aaron Lee Smith, Chesapeake, VA (US)

(21) Appl. No.: 17/945,218

(22) Filed: Sep. 15, 2022

(51) Int. Cl. G06Q 10/0639; G06Q 10/1053

(52) U.S. Cl. CPC G06Q 10/06393; G06Q 10/1053

(57) ABSTRACT

A dashboard capable of extracting skills in jobs and analyzing those skills for other jobs is disclosed. It utilizes multiple API and datasets from across the world that continue to update over time, showing the current description regardless of location or region. This gives the user the best information possible to identify what jobs within the company have the easiest chance to transition into another job.

### FIELD OF THE INVENTION

The present invention generally relates to a skill assessment platform. More particularly, this invention relates to a skill extracting and analysis platform used to analyze job skills, compare those skills to other jobs, and create reports based on the assessments. The platform software is designed to reduce the number of laid-off employees and help small businesses identify what additional skills carry over between job descriptions. The platform specifically uses questions in the assessment examination to develop the software. The present system also addresses dependency management and risk assessment. It enhances good practice-sharing, as questions related to good practices are asked of all participants, which led to a possible comparison of practice usage calibrated to assess various job positions within an organization.

### BACKGROUND

Effective methods for collecting and presenting career-related information to employees, prospective employees, employers, and prospective employers are particularly important in today's job market, where multiple career opportunities and potential career paths exist and where effective employee recruitment and retention can significantly affect both the success of an organization and its employees.

Employee turnover is a persistent problem in the business arena. Not only does turnover affect workplace morale, but the expense of replacing employees can be high, depending upon expertise. When companies decide to lay off or RIFt employees, companies look at variables such as salaries, experience, and performance evaluations. To address laid-off employee issues, an organization may employ AI software to track employee performance metrics, determine competency gaps, and set employee goals to facilitate scheduling learning activities because of perceived performance needs. However, such AI software is typically very expensive. It does not specifically address an employee's (or prospective employee's) questions about overall career paths and the requisite skills and steps needed to proceed along the desired path given their individual preferences.

### SUMMARY

The purpose of the software dashboard is to show Human Resource personnel how to transfer employees between job positions. This is achieved by analyzing different job description similarities and data comparisons of users' skills, commons, and differences. It provides an option for small businesses that cannot purchase a larger-scale AI platform to analyze employees. In a specific embodiment, acquiring user information includes providing a questionnaire to a user and receiving questionnaire answers in response thereto. Obtaining aggregated information, the profile information may be retrieved from a Human Capital Management (HCM), performance management system, social network system, or other Enterprise Resource Planning (ERP) system component of an organization. A further understanding of the nature and the advantages of embodiments disclosed will be realized by referencing the remaining portions of the specification and the attached drawings.

### BRIEF DESCRIPTION OF THE DRAWINGS

FIG. 1 is diagram of the network interface of the system.

FIG. 2 is a diagram of a first example embodiment of a system for providing career-related information.

### DETAILED DESCRIPTION OF EMBODIMENTS

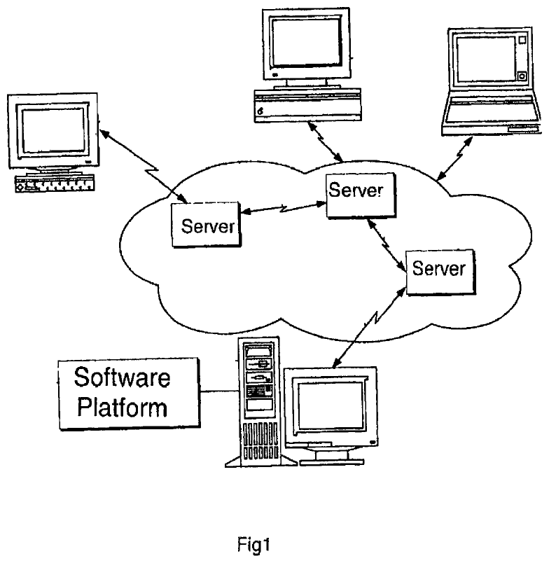

FIG. 1 A dashboard software capable of extracting job skills and analyzing those skills for other jobs is disclosed. It utilizes many APIs and datasets from servers worldwide and then continues to update over time, showing the current description regardless of place in the world. Scouring the web for data sets and APIs for data. Afterward, a template dashboard is created with many logic gates to correctly pull out the respective data.

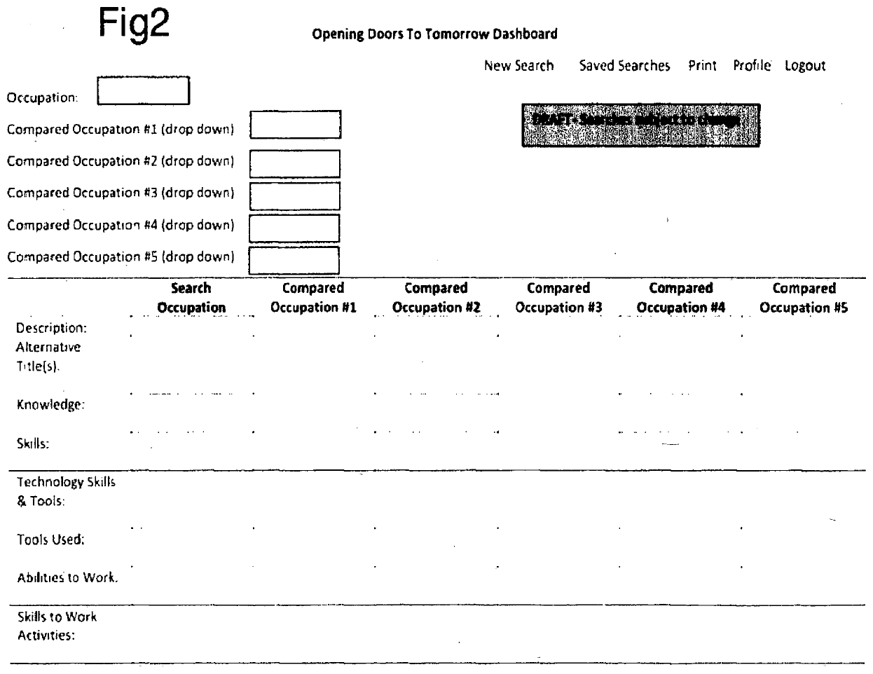

FIG. 2 The dashboard reduces the number of people being laid off and helps small businesses discover what additional skills are needed to acquire another employee. Each questionnaire creates a systematic process for the HR personnel to use to build the dashboard.

1. The dashboard software is designed to reduce the number of employees laid off while helping small businesses make informed decisions on personnel retention.
